(19) United States
(12) Patent Application Publication
(10) Pub. No.: US 2022/0185681 A1
(43) Pub. Date: Jun. 16, 2022

(54) METHOD OF PRODUCING NANOPARTICLES

(71) Applicant: DOW SILICONES CORPORATION, Midland, MI (US)

(72) Inventors: James Allen CASEY, Midland, MI (US); Charles SERRANO, Midland, MI (US); David Lawrence WITKER, Midland, MI (US)

(21) Appl. No.: 17/598,251

(22) PCT Filed: Mar. 31, 2020
(86) PCT No.: PCT/US2020/025975

§ 371 Date: Sep. 25, 2021

Related U.S. Application Data
(60) Provisional application No. 62/827,130, filed on Mar. 31, 2019.

(51) Int. Cl. C01B 33/03; B01J 19/08

(52) U.S. Cl. CPC C01B 33/03; B01J 2219/0894; B01J 19/088

(57) ABSTRACT

Disclosed is a method for producing silicon nanoparticles in a plasma reactor including a reaction chamber presenting an inner surface. The method includes introducing a halogen gas into the reaction chamber of the plasma reactor. The method further includes igniting a plasma within the reaction chamber while the halogen gas is present within the reaction chamber. Atoms of the halogen gas at least partially form a coating on the inure surface of the reaction chamber. The method includes introducing a reactant gas mixture including a silicon precursor gas and a first inert gas into the reaction chamber of the plasma reactor. The method also includes forming the silicon nanoparticles in the plasma reactor. A silicon nanoparticles composition is also disclosed. The silicon nanoparticles composition comprises the silicon nanoparticles produced according to the method.

### CROSS REFERENCE TO RELATED APPLICATIONS

The application claims priority to and all advantages of U.S. Provisional Patent Application No. 62/827,130 filed on 31 Mar. 2019, the content of which is incorporated herein by reference.

### FIELD OF THE INVENTION

The disclosure relates to a method producing of nanoparticles and, more specifically, to methods of producing silicon nanoparticles in a plasma reactor.

### DESCRIPTION OF THE RELATED ART

Nanoparticles are known in the art and can be prepared via various processes. Nanoparticles are often defined as particles having at least one dimension of less than 100 nanometers. Nanoparticles are produced either from a bulk material, which is initially larger than a nanoparticle, or from particles smaller than the silicon nanoparticles, such as ions and/or atoms. Nanoparticles are particularly unique in that they may have significantly different properties than the bulk material or the smaller particles from which the silicon nanoparticles are derived. For example, a bulk material that acts as an insulator or semiconductor can be, when in nanoparticle form, electrically conductive or photoluminescent.

An important characteristic of small (<5 nm diameter) silicon nanoparticles is that they photoluminesce visible light when stimulated. Silicon nanoparticles may be used in various applications including in optoelectronics, diagnostics, analytics, and cosmetics. Silicon nanoparticles have additional physical characteristics that differ from a bulk material, such as melting points that vary as a function of particle diameter.

### BRIEF SUMMARY OF THE INVENTION

A method for producing silicon nanoparticles in a plasma reactor including a reaction chamber presenting an inner surface is provided. The method includes introducing a halogen gas into the reaction chamber of the plasma reactor. The method further includes igniting a plasma within the reaction chamber while the halogen gas is present within the reaction chamber. Atoms of the halogen gas at least partially form a coating on the inner surface of the reaction chamber. The method also includes introducing a reactant gas mixture including a silicon precursor gas and a first inert gas into the reaction chamber of the plasma reactor. The method further includes forming the silicon nanoparticles in the plasma reactor.

Silicon nanoparticles produced by the above method are also provided.

A silicon nanoparticles composition is further provided. The silicon nanoparticles composition comprises the silicon nanoparticles produced according to the above method.

### BRIEF DESCRIPTION OF THE DRAWINGS

Other advantages and aspects of this invention described in the following detailed description may be further understood when considered in connection with the accompanying drawings, wherein:

FIG. 1 illustrates one embodiment of a low pressure high frequency pulsed plasma reactor for producing silicon nanoparticles;

FIG. 2 illustrates an embodiment of a system including a low pressure pulsed plasma reactor to produce silicon nanoparticles and a diffusion pump to collect the silicon nanoparticles;

FIG. 3 illustrates a schematic view of one embodiment of a diffusion pump for collecting silicon nanoparticles produced via a reactor;

FIG. 4 shows emission intensities of nanoparticles formed in Examples 1 and 2 and Comparative Example 1; and

FIG. 5 shows emission intensities of nanoparticles formed in Examples 3-5.

### DETAILED DESCRIPTION OF THE INVENTION

The present invention provides a method for producing silicon nanoparticles, silicon nanoparticles produced by the method, and compositions comprising the silicon nanoparticles. The silicon nanoparticles have excellent physical properties and are suitable for myriad end use applications, ranging from optoelectronics to cosmetics.

The method is carried out in a plasma reactor including a reaction chamber presenting an inner surface. The plasma reactor and reaction chamber are described in greater detail below.

The method includes introducing a halogen gas into the reaction chamber of the plasma reactor. The method further includes igniting a plasma within the reaction chamber while the halogen gas is present within the reaction chamber. Atoms of the halogen gas at least partially form a coating on the inner surface of the reaction chamber.

Non-limiting examples of halogen gases include gaseous diatomic molecules consisting of elements selected from Group 17 of the periodic table, such as chlorine gas (Cl₂), fluorine gas (Fl₂), bromine gas (Br₂), iodine gas (I₂), and mixtures thereof. Alternatively, the halogen gas may comprise a metal halide or other halogen-containing gas. However, typically, the halogen gas is a diatomic halogen gas free from non-halogen atoms.

Typically, the method comprises introducing the halogen gas to the reaction chamber prior to the introduction of the reactant gas mixture, as described below. In such embodiments, introduction of the halogen gas to the reaction chamber is separate and distinct from introducing the reactant gas mixture to the reaction chamber, although the reactant gas mixture may also optionally comprise a halogen gas. Unlike the introduction of the reactant gas mixture, introduction of the halogen gas does not include introduction of a precursor gas. Introducing the halogen gas to the reaction chamber prior to the introduction of the reactant gas mixture results in improved physical properties of the silicon nanoparticles formed by the reactant gas mixture in the method.

In certain embodiments, the halogen gas is introduced into the reaction chamber and a plasma is ignited before each process of producing silicon nanoparticles in the plasma reactor. However, it is contemplated that there can be a time delay, or additional process with the plasma reactor, between introducing the halogen gas into the reaction chamber and producing nanoparticles with the plasma reactor from the reactant gas mixture described below.

In certain embodiments, introducing the halogen gas to the reaction chamber further comprises introducing an initial inert gas to the reaction chamber along with the halogen gas.

The initial inert gas is generally non-reactive within any of the molecules or atoms of the halogen gas or with the reaction chamber itself. Examples of inert gasses include noble gases such as helium, neon, argon, krypton, xenon, and combinations thereof. When utilized, the initial inert gas is typically utilized in an amount of from 1 to 99% v/v, based on the total volume of the halogen gas and the initial inert gas. The halogen gas and the initial inert gas may be separately introduced or introduced together into the reaction chamber, e.g. in a single stream or in separate streams that combine in the reaction chamber. In certain embodiments, the halogen gas and the initial inert gas are introduced into the reactor free from any other reactant or precursor gases, alternatively free from any other gasses altogether.

The reaction chamber typically comprises a material suitable for plasma processes. In certain embodiments, the reaction chamber comprises, alternatively is, quartz. In certain embodiments, the inner surface of the reaction chamber includes a first coating comprising silicon atoms. One of skill in the art readily appreciates how to form the first coating comprising, alternatively consisting essentially of, silicon atoms on the inner surface of the reaction chamber. For example, the first coating cam be formed by chemical or physical methods. For example, the first coating can be formed via a silane deposition process, as known in the art. Alternatively, the first coating can be formed from prior use of the reaction chamber in generating silicon nanoparticles, as silicon is generally deposited to form the first coating in carrying out such production of silicon nanoparticles.

The method further comprising igniting a plasma within the reaction chamber while the reaction gas is present within the reaction chamber. Parameters for igniting the plasma are described below with respect to producing the silicon nanoparticles via the plasma process. The parameters for igniting the plasma may be the same as or different from parameters for igniting the plasma when producing the silicon nanoparticles, and each step of igniting the plasma is independently selected. However, for purposes of brevity, parameters for igniting the plasma are described collectively below with reference to producing the silicon nanoparticles.

When the plasma is ignited in the reaction chamber with the halogen gas present therein, the method at least partially forms a coating on the inner surface of the reaction chamber. By at least partially forms a coating, it means that the coating on the inner surface may be continuous or discontinuous, and may vary in any characteristic, e.g. composition, thickness, etc. The coating typically comprises halogen atoms. When the first coating is present on the inner surface of the reaction chamber, the coating comprises silicon atoms and halogen atoms. For example, the coating may comprise a halosilanes. When the coating comprises, alternatively consists of, silicon atoms and halogen atoms, the silicon atoms and halogen atoms may be bonded together (e.g. in the case of halosilanes atoms), and/or may be physically adjacent one another in the coating. Formation of the coating may result in degradation of the first coating, and the first coating and the coating may be indistinguishable from one another upon formation of the coating. The coating generally serves to passivate the silicon nanoparticles as they are formed via the inventive method, thus imparting improved and excellent physical properties, particularly optical properties.

In various embodiments, an amount of the halogen gas utilized is based on desired characteristics of the coating. In certain embodiments, the halogen gas is utilized at a flow rate to selectively control a molar ratio of silicon atoms to halogen atoms in the coating. This molar ratio of silicon atoms to halogen atoms can also be selectively controlled throughout the inventive method, e.g. by utilizing further amounts of the halogen gas later in the process (e.g. in the reactant gas mixture) if the coating degrades during the production of silicon nanoparticles.

In various embodiments, the plasma process used to prepare the silicon nanoparticles (which may alternatively be referred to as simply nanoparticles) is carried out in the plasma reactor. In various embodiments, the silicon nanoparticles comprise, in addition to silicon, an independently selected Group IV element. As used herein, the group designations of the periodic table are generally from the CAS or old IUPAC nomenclature, where Group IV elements are referred to as Group 14 elements under the modern IUPAC system, as readily understood in the art. As used herein, the Group IV elements include C, Si, Ge, Sn, Pb, and Fl. Typically, the Group IV element(s) of the silicon nanoparticles is selected from Si, Ge, Sn, and combinations thereof.

In certain embodiments where the plasma process is carried out in the low pressure reactor, the plasma process comprises forming a nanoparticle aerosol in the low pressure reactor, wherein the aerosol comprises silicon nanoparticles entrained in a gas. The silicon nanoparticles are generally collected upon their formation. In certain embodiments, as described below, the silicon nanoparticles are collected by capturing the silicon nanoparticles in a capture fluid, which is typically in fluid communication with the low pressure reactor.

Regardless of the particular plasma system and process utilized to produce the silicon nanoparticles, the plasma system generally relies on a silicon precursor gas. The silicon precursor gas is generally selected based on the desired composition of the silicon nanoparticles.

The precursor gas is generally selected based on the desired composition of the nanoparticles. For example, as introduced above, the precursor gas typically comprises silicon. When the silicon nanoparticles comprise at least one other element, the precursor gas generally comprises atoms selected from germanium, tin, and/or other Group IV elements.

In certain embodiments, the precursor gas comprises silicon, which may be present or provided in the form of silicon compounds including silanes, disilanes, halogen-substituted silanes, halogen-substituted disilanes, C₁-C₄ alkyl silanes, C₁-C₄ alkyldisilanes, and the like, as well as derivatives and/or combinations thereof. For example, in some embodiments, the precursor gas comprises a silicon compound in an amount of from 0.1 to 2%, alternatively from 0.1 to 50% by volume of the precursor gas. In some such embodiments, the reactant gas mixture comprises the silicon compound in an amount of from 0.1 to 2%, alternatively from 0.1 to 50% by volume of the reactant gas mixture.

General examples of silicon compounds suitable for use in or as the precursor gas include alkylsilanes and aromatic silanes. Some specific examples of silicon compounds suitable for use in or as the precursor gas include dimethylsilane (H₃C—SiH₂—CH₃), tetraethyl silane ((CH₃CH₂)₄Si) and diphenylsilane (Ph—SiH₂—Ph)disilane (Si₂H₆), silicon tetrachloride (SiCl₄), trichlorosilane (HSiCl₃), dichlorosilane (H₂SiCl₂). In particular embodiments, the silicon compound comprises SiCl₄, HSiCl₃, and/or H₂SiCl₂.

In some embodiments, the precursor gas comprises further germanium, which may be present or provided in the form of germanium compounds including germanes, digermanes, halogen-substituted germanes, halogen-substituted digermanes, C₁-C₄ alkyl germanes, C₁-C₄ alkyldigermanes, and the like, as well as derivatives and/or combinations thereof. Particular examples of germanium compounds suitable for use in or as the precursor gas include tetraethyl germane ((CH₃CH₂)₄Ge) and diphenylgermane (Ph—GeH₂—Ph). The precursor gas may comprise both silicon and germanium, along with any other group IV elements.

In some embodiments, the precursor gas further comprises an organometallic precursor compound comprising Group IV metal. Examples of such organometallic precursor compounds include organosilicon compounds, organogermanium compounds, and organotin compounds, such as alkylgermanium compounds, alkylsilane compounds, alkylstannane compounds, chlorosilane compounds, chlorogermanium compounds, chlorostannane compounds, aromatic silane compounds, aromatic germanium compounds, aromatic stannane compounds, and the like, as well as derivatives and/or combinations thereof. In these or other embodiments, the precursor has comprises a hydrogen gas, a halogen gas (e.g. a chlorine gas, a bromine gas, etc.), or both. In particular embodiments, the precursor gas comprises a compound comprising an atom of a Group IV element as well as H and/or halogen atoms.

Typically, the reactant gas mixture comprises the precursor gas in an amount of from 0.1 to 50, alternatively from 1 to 50, volume percent based on the total volume of the reactant gas mixture.

In some embodiments, the reactant gas mixture further comprises a halogen gas (e.g. chlorine gas (Cl₂)). The halogen gas may be present in the precursor gas, e.g. in a combined feed, or utilized as a separate feed along with or separate from the precursor gas. The relative amount of the halogen gas, if utilized, may be optimized based upon a variety of factors, such as the precursor gas selected, etc. For example, lesser amounts of the halogen gas may be required to prepare halogen-functional nanoparticles when the precursor gas comprises halogen atoms. In certain embodiments, the halogen gas is utilized in an amount of from greater than 0 to 25, alternatively from 1 to 25, alternatively from 1 to 10%, v/v of the total volume of the reactant gas mixture.

The reactant gas mixture may comprise other gases, i.e., aside from the precursor gas. In particular embodiments, the reactant gas mixture comprises an inert gas. The inert gas is generally non-reactive within any of the molecules or atoms present within the plasma stream during the operation of the plasma reactor. Examples of inert gasses include noble gases such as helium, neon, argon, krypton, xenon, and combinations thereof. When utilized, the inert gas is typically present in an amount of from 1 to 99% v/v, based on the total volume of the reactant gas mixture.

The reactant gas mixture may comprise a dopant, e.g. a source of an atom to be integrated (i.e., “doped”) into the nanoparticles formed in the plasma reactor during the method. In such embodiments, the dopant may alternatively be referred to as a second precursor gas. In some embodiments, the nanoparticles undergo gas phase doping in the plasma, where the reactant gas mixture comprises a first precursor gas comprising silicon to form a silicon nanoparticle and a second precursor gas comprising another element, which is dissociated and is incorporated in the nanoparticles as they nucleate. Of course, the nanoparticles (i.e., once formed) may also or alternatively be doped, e.g. downstream of the production of the nanoparticles but prior to the nanoparticles being collected in the capture fluid. In some embodiments, the reactant gas mixture comprises a dopant comprising carbon, germanium, boron, phosphorous, and/or nitrogen, such as trimethylsilane, disilane, trisilane, BCl₃, B₂H₆, PH₃, GeH₄, GeCl₄, and the like, and combinations thereof. In certain embodiments, the reactant gas mixture comprises the dopant in an amount of from 0.1 to 49.9% v/v based on total volume of the reactant gas mixture. In some embodiments, the reactant gas mixture comprises a combined amount of the precursor gas and the dopant of from 0.1 to 50% v/v based on the total volume of the reactant gas mixture.

In particular embodiments, the reactant gas mixture comprises hydrogen gas. Typically, in such embodiments, the reactant gas mixture comprises hydrogen gas in an amount of from 1 to 50, alternatively from 1 to 2%, alternatively from 1 to 10%, by volume based on total volume of the reactant gas mixture.

In one form of the present disclosure, the silicon nanoparticles may comprise alloys of Group IV elements, e.g. silicon alloys. Silicon alloys that may be formed include, but are not limited to, silicon carbide, silicon germanium, silicon boron, silicon phosphorous, and silicon nitride. The silicon alloys may be formed by mixing at least one first precursor gas with the second precursor gas or using a precursor gas that contains the different elements. However, other methods of forming alloyed silicon nanoparticles are also contemplated.

In various embodiments, the plasma reactor is a component of a plasma system (alternatively referred to as a plasma reactor system). Specific embodiments of plasma reactor systems particularly suitable for the instant method are described below. It is to be appreciated that the specific embodiments described below are merely examples of exemplary plasma processes suitable for producing silicon nanoparticles.

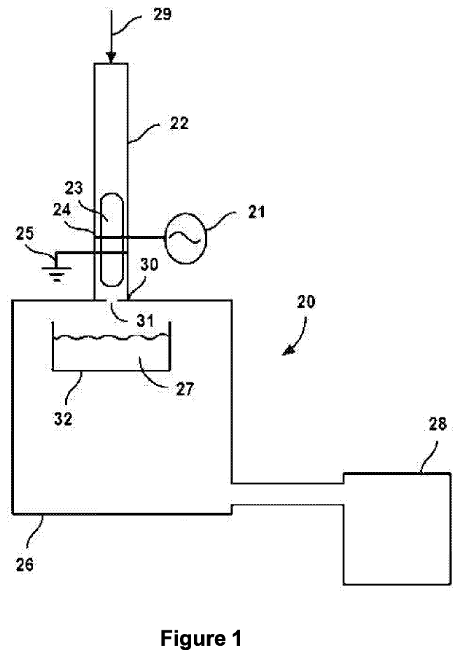

The plasma reactor is not particularly limited, such that any plasma reactor, or systems comprising a plasma reactor, may be utilized to prepare the nanoparticle aerosol. In certain embodiments, the plasma reactor is a component of a plasma reactor system (alternatively referred to as a plasma system), which may be, e.g. a very high frequency low pressure plasma reactor system, a low pressure high frequency plasma reactor system, etc. Such plasma reactor systems are exemplified in FIG. 1, which shows a plasma reactor system generally at 20. The plasma reactor system 20 comprises a plasma generating chamber 22, a particle collection chamber 26 in fluid communication with the plasma generating chamber 22, and a vacuum source 28 in fluid communication with the particle collection chamber 26 and plasma generating chamber 22.

The plasma generating chamber 22, which may alternatively be referred to as a plasma reactor and/or as a discharge tube, comprises a high frequency (HF) or very high frequency (VHF) radio frequency (RF) power source (not shown). Power is supplied from the power source via the variable frequency RF power amplifier 21 that is triggered by an arbitrary function generator to establish a high frequency pulsed plasma (alternatively referred to simply as a plasma) in the area shown at 23. Typically, radiofrequency power is capacitively coupled into the plasma creating a capacitively coupled plasma discharge using a ring electrode, parallel plates, or an anode/cathode setup in the gas. Alternatively, the radiofrequency power may be inductively coupled into the plasma using an RF coil disposed around the discharge tube 22 in an inductively coupled plasma (ICP) reactor arrangement.

The plasma generating chamber 22 also comprises an electrode configuration 24 that is attached to a variable RF power amplifier 21. The plasma generating chamber 22 also comprises a second electrode configuration 25. The second electrode configuration 25 may be ground, DC biased, or operated in a push-pull manner relative to the electrode configuration 24. The plasma generating chamber 22 also includes a reactant gas inlet 29, and an outlet 30 that defines an aperture or orifice 31. The plasma generating chamber 22 may also comprise a dielectric discharge tube (not shown). In various embodiments, the plasma generating chamber 22 comprises quartz.

In some embodiments, the electrode configurations 24, 25 for the plasma generating chamber 22 comprise a flow-through showerhead design, in which a VHF radio frequency biased upstream porous electrode plate 24 is separated from a downstream porous electrode plate 25, with the pores of the plates 24, 25 aligned with one another. The pores may be circular, rectangular, or any other desirable shape.

The particle collection chamber 26, which may alternatively be referred to as a deposition chamber and/or a vacuum particle collection chamber, generally contains a container 32.

The vacuum source 28 typically comprises a vacuum pump. In certain embodiments, however, the vacuum source 28 may comprise a mechanical, turbo molecular, diffusion, or cryogenic pump. During operation, portions of the plasma generating chamber 22 may be evacuated to a reduced pressure (i.e., a vacuum level), e.g. a pressure of from 1×10⁻⁷ to 500 Torr, alternatively of from 100 mTorr to 10 Torr.

In operation, the electrode configurations 24, 25 are used to couple the HF or VHF power to a reactant gas mixture to ignite and sustain a glow discharge of plasma (i.e., “igniting a plasma”) within the area identified shown at 23. In certain embodiments, the reactant gas mixture, which may alternatively be referred to as a first reactive precursor gas, enters the dielectric discharge tube (not shown) where the plasma is generated. Regardless, molecular components of the reactant gas mixture are dissociated in the plasma as charged atoms, which nucleate to form nanoparticles from the reactant gas mixture and give an aerosol comprising the silicon nanoparticles in the gas (i.e., a “nanoparticle aerosol”). This aerosol is then transported to the particle collection chamber 26 and, in particular, to the container 32.

More specifically, the particle collection chamber 26 generally comprises a capture fluid 27 that is disposed in the container 32 and used to capture nanoparticles. The container 32 or the capture fluid 27 may be adapted to be agitated (e.g. stirred, rotated, inverted, sonicated, etc.) (not shown), such as via a rotatable support, a stirring mechanism, etc. In some embodiments, the capture fluid 27 is agitated to refresh a surface of the capture fluid 27 and to force captured nanoparticles therein away from a centerline of the orifice 32. In this fashion, absorption rates of nanoparticles into the capture fluid 27 may be increased by increasing the agitation of the capture fluid 27. For example, in certain embodiments, ultrasonication may be utilized as an increased method of agitating the capture fluid 27. Typically, the capture fluid 27 is a liquid at the temperatures of operation of the plasma reactor system 20.

Generally, nanoparticles produced via the plasma reactor system 20 may be varied/controlled with respect to nanoparticle diameter by varying a distance between the aperture 31 in the outlet 30 of the plasma generating chamber 22 and the surface of the capture fluid 27 (i.e., the “collection distance”). The collection distance typically ranges from 5 to 50 times a diameter of the aperture 31 (i.e., from 5 to 50 “aperture diameters”). Positioning the surface of the capture fluid 27 too close to the aperture 31 may result in undesirable interactions of plasma with the capture fluid 27. Conversely, positioning the surface of the capture fluid 27 too far from the aperture 31 may reduce nanoparticle collection efficiency. As the collection distance is a function of the diameter of the aperture 31 and a pressure drop between the plasma generating chamber 22 and the collection chamber 26, an acceptable collection distance is typically from 1 cm to 20 cm, alternatively from 5 cm to 10 cm, alternatively from 6 cm to 12 cm, based on the operating conditions described herein.

In some embodiments, the HF or VHF radio frequency power source (not shown) operates at a preselected RF in a frequency range of 10 to 500 MHz to generate plasma for a time sufficient to form the nanoparticle aerosol. The preselected radio frequency may be a continuous frequency of from 10 to 500 MHz, alternatively of from 30 MHz to 150 MHz, and typically corresponds to a coupled power of from 5 to 1000 W, alternatively from 1 W to 200 W, respectively. In certain embodiments, the preselected radio frequency is a continuous frequency of from 100 to 150 MHz.

In some embodiments, the plasma generating chamber 22 may include an electrode 24 that is coupled to the VHF radio frequency power source and has a pointed tip (not shown) spaced apart by a variable distance from a grounded ring (not shown) inside the plasma generating chamber 22. The pointed tip can alternatively be positioned at a variable distance from a VHF radio frequency powered ring operated in a push-pull mode (180° out of phase). In some embodiments, the electrode configuration 24, 25 includes an inductive coil (not shown) coupled to the VHF radio frequency power source so that radio frequency power is delivered to the reactant gas mixture by an electric field formed by the inductive coil.

The plasma in area 23 is initiated (alternatively referred to as being ignited) via an RF power amplifier such as, for example, an AR Worldwide Model KAA2040, or an Electronics and Innovation Model 3200L, or an EM Power RF Systems, Inc. Model BBS2E3KUT. The amplifier can be driven (or pulsed) by an arbitrary function generator (e.g., a Tektronix AFG3252 function generator) that is capable of producing up to 200 watts of power from 0.15 to 150 MHz. In some embodiments, the arbitrary function may be able to drive the power amplifier with pulse trains, amplitude modulation, frequency modulation, or different waveforms. Power coupling between the amplifier and the reactant gas mixture typically increases as the frequency of the RF power increases. Driving power at a higher frequency may allow more efficient coupling between the power supply and discharge. Increased coupling may be manifested as a decrease in the voltage standing wave ratio (VSWR) according to formula 1:

$$VSWR = \frac{1 + p}{1 - p} , \qquad ( 1 )$$

where p is the reflection coefficient:

$$p = \frac{Z p - Z c}{Z c + Z p} , \qquad ( 2 )$$

where Zp and Zc representing the impedance of the plasma and coil respectively. At frequencies below 30 MHz, only 2-15% of the power is delivered to the plasma discharge, producing high reflected power in and RF circuit that leads to increased heating and limited lifetime of the power supply. In contrast, higher frequencies may be used to allow more power to be delivered to the plasma discharge, thereby reducing the amount of reflected power in the RF circuit.

In some embodiments, the power and frequency of the plasma discharge is preselected to create an optimal operating space for the formation of nanoparticles. Typically, tuning both power and frequency creates an appropriate ion and electron energy distribution in the plasma discharge to help dissociate the molecules of the reactant gas mixture and nucleate the silicon nanoparticles. The power of the plasma discharge controls the temperature of individual particles within the plasma discharge. By controlling the temperature of individual particles within the plasma discharge, it is possible to control the crystallinity of the silicon nanoparticles formed within the plasma discharge. Typically, higher power yields crystalline particles, while low power produces amorphous particles. Controlling both power and frequency may also be utilized to prevent the silicon nanoparticles from growing too large.

The plasma reactor system 20 may be pulsed to directly manage the residence time for nanoparticle nucleation, and thereby control the particle size distribution and agglomeration kinetics in the plasma. In general, pulsing the system 20 allows for controlled tuning of the particle residence time in the plasma, which affects the size of the silicon nanoparticles formed therein. By decreasing “on” time of the plasma, nucleating particles have less time to agglomerate, and therefore the size of the silicon nanoparticles may be reduced on average (i.e., the nanoparticle distribution may be shifted to smaller diameter particle sizes). Likewise, a distance between the nanoparticle synthesis location and the surface of the capture fluid 27 is typically selected to be sufficiently short in order to avoid unwanted agglomeration of entrained nanoparticles.

The size distribution of the silicon nanoparticles can also be controlled by controlling the plasma residence time, a high ion energy/density region of the VHF radio frequency low pressure glow discharge relative to a residence time of a precursor gas molecular through the discharge. Typically, at constant operating conditions (e.g. discharge drive frequency, drive amplitude, discharge tube pressure, chamber pressure, plasma power density, precursor mass flow rates, collection distance from plasma source electrodes, etc.) a lower plasma residence time of a VHF radio frequency low pressure glow discharge relative to the gas molecular residence time, corresponds to a decreased mean nanoparticle diameter at constant operating conditions. For example, as the plasma residence time of a VHF radio frequency low pressure glow discharge relative to the gas molecular residence time increases, the mean nanoparticle diameter follows an exponential growth model of the form y=y₀−exp(−tᵣ/C), where y is the mean nanoparticle diameter, y₀ is the offset, tᵣ is the plasma residence time, and C is a constant. The particle size distribution may also be increased by increasing plasma residence time under otherwise constant operating conditions.

In some embodiments, the mean particle diameter of the nucleated nanoparticles (as well as the nanoparticle size distribution) can be controlled by controlling a mass flow rate of at least one precursor gas in a VHF radio frequency low pressure glow discharge. For example, as the mass flow rate of precursor gas (or gases) increases in the VHF radio frequency low pressure plasma discharge, the synthesized mean nanoparticle diameter may decrease following an exponential decay model of the form y=y₀+exp(−MFR/C′), where y is the mean nanoparticle diameter, y₀ is the offset, MFR is the precursor mass flow rate, and C′ is a constant, for constant operating conditions. Typical operating conditions may include discharge drive frequency, drive amplitude, discharge tube pressure, chamber pressure, plasma power density, gas molecule residence time through the plasma, and collection distance from plasma source electrodes. The synthesized mean nanoparticle size distribution may also decrease as an exponential decay model of the form y=y₀+exp(−MFR/K), where y is the mean nanoparticle diameter, y₀ is the offset, MFR is the precursor mass flow rate, and K is a constant, for constant operating conditions.

Typically, operating the plasma reactor system 20 at higher frequency ranges and pulsing the plasma provides the same conditions as conventional constricted/filament discharge techniques that use plasma instability to produce high ion energies/densities, but with the additional advantage that users can control operating conditions to select and produce nanoparticles predetermined sizes, which impacts certain characteristic physical properties (e.g. photoluminescence).

For a pulse injection, the synthesis (which may alternatively be referred to as deposition) of nanoparticles can be achieved using a pulsed energy source, such as a pulsed very high frequency RF plasma, a high frequency RF plasma, or a pulsed laser for pyrolysis. Typically, the VHF radiofrequency is pulsed at a frequency ranging from 1 to 50 kHz.

As described above, the aerosol comprising the silicon nanoparticles are transferred from the plasma reactor 22 to collection chamber 26 and, in particular, to the capture fluid 27 disposed in the container 32. In certain embodiments, the silicon nanoparticles are transferred to the capture fluid 27 by pulsing input of the reactant gas mixture while the plasma is ignited. For example, in some such embodiments, the plasma is ignited with a first reactive precursor gas present to synthesize the silicon nanoparticles, with at least one other gas present to sustain the discharge, such as an inert gas. The synthesis of the silicon nanoparticles is stopped by stopping the flow of first reactive precursor gas (e.g. with a mass flow controller), and then resumed by flowing the first reactive precursor gas again. This pulsed stream technique can be used to increase the concentration of nanoparticles in the capture fluid 27, e.g. when the flux of functional nanoparticles impinging on the capture fluid 27 is greater than the absorption rate of the silicon nanoparticles into the capture fluid 27. In certain embodiments, the silicon nanoparticles are evacuated from the plasma reactor 22 to the particle collection chamber 26 (e.g. to the capture fluid 27 disposed in the container 32) by cycling the plasma to a low ion energy state and/or turning the plasma off.

In some embodiments, the silicon nanoparticles are transferred from the plasma generating chamber 22 to the capture fluid 27 via a pressure differential between the plasma generating chamber 22 and the particle collection chamber 26, which can be controlled through a variety of means, and may be sufficient to create a supersonic jet of nanoparticles streaming out of the plasma generating chamber 22. The supersonic jet minimizes gas phase particle-to-particle interactions, thus keeping the silicon nanoparticles monodispersed in the gas stream. In particular embodiments, the discharge tube 22 has an inside diameter that is much less than an inside diameter of the particle collection chamber 26, thus creating the pressure differential (e.g. where the pressure of the particle collection chamber 26 is less than the pressure of the reaction chamber 22). In various embodiments the pressure of the deposition chamber is <1×10⁻⁵ Torr, which may be controlled via the vacuum source 28. In some embodiments, the orifice 31 is adapted to force the plasma to reside partially inside the orifice 31, e.g. based on Debye length of the plasma and size of the plasma generation chamber 22. In certain embodiments, orifice 31 may be varied electrostatically to develop a positive concentric charge that forces the negatively charged plasma through the aperture 31.

As introduced above, upon the dissociation of molecules of the reactant gas mixture in the plasma generation chamber 22, nanoparticles form and are entrained in the gas phase. The distance between the nanoparticle synthesis location and the surface of capture fluid 27 must be short enough so that no unwanted nucleation or functionalization occurs while the silicon nanoparticles are entrained in the gas phase, but instead the silicon nanoparticles interact within the gas phase, and agglomerations of numerous, individual small nanoparticles form and are captured in the capture fluid 27. If too much interaction takes place within the gas phase, the silicon nanoparticles may sinter together and form nanoparticles having larger average diameters.

Additional examples relating to reactors suitable for the present embodiments are described in the disclosures of International (PCT) Publication Nos. WO 2010/027959 and WO 2011/109229, each of which is being incorporated herein by reference in its respective entirety. Such reactors can be, but are not limited to, low pressure high frequency pulsed plasma reactors.

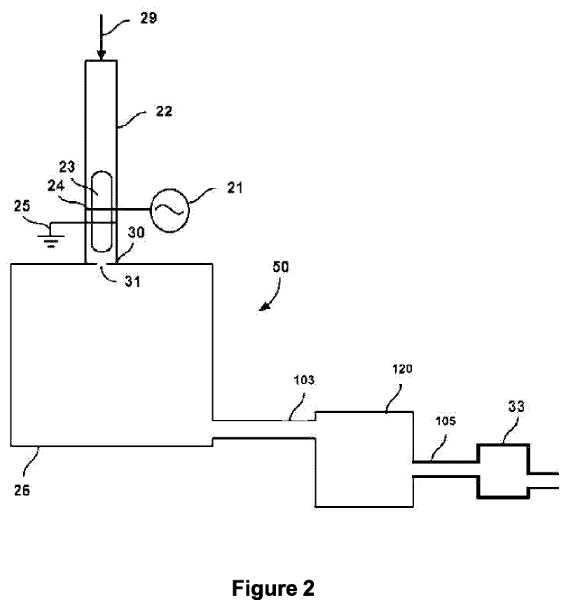

It will be appreciated that other plasma reactors and plasma reactor systems may be utilized. For example, in certain embodiments, the method may be performed utilizing a plasma reactor system exemplified by the plasma reactor system shown generally at 50 in FIG. 2. In these embodiments, the silicon nanoparticles are prepared in the plasma reactor system 50, which, like the prior plasma reactor system described above, includes the plasma generation chamber 22.

In these embodiments, the plasma reactor system 50 includes a diffusion pump 120. As such, the silicon nanoparticles can be collected by the diffusion pump 120. The particle collection chamber 26 may be in fluid communication with the plasma generating chamber 22. The diffusion pump 120 may be in fluid communication with the particle collection chamber 26 and the plasma generating chamber 22. In other forms of the present disclosure, the plasma reactor system 50 may exclude the particle collection chamber 26. For example, the outlet 30 may be coupled to an inlet 103 of the diffusion pump 120, or the diffusion pump 120 may be in substantially direct fluid communication with the plasma generating chamber 22.

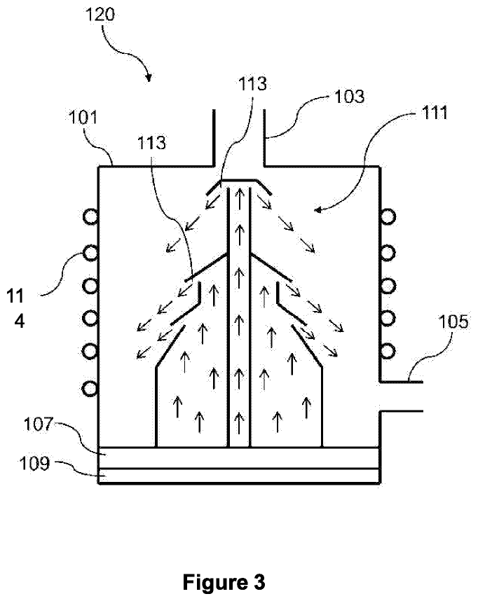

FIG. 3 is a cross-sectional schematic of an example diffusion pump 120 suitable for the plasma reactor system 50 of the embodiments of FIG. 2. The diffusion pump 120 can include a chamber 101 having an inlet 103 and an outlet 105. The inlet 103 may have a diameter of 5 cm to 140 cm, and the outlet may have a diameter of 1 cm to 21 cm. The inlet 103 of the chamber 101 is in fluid communication with the outlet 30 of the reactor 20. The diffusion pump 120 may have, for example, a pumping speed of 65 to 65,000 liters/second or greater than 65,000 liters/second.

The diffusion pump 120 also includes a reservoir 107 in fluid communication with the chamber 101. The reservoir 107 supports or contains the capture fluid. The reservoir may have a volume of 30 ml to 15 liters. The volume of the capture fluid in the diffusion pump may be 30 ml to 15 liters. The diffusion pump 120 can further include a heater 109 for vaporizing the capture fluid in the reservoir 107. The heater 109 heats up the capture fluid and vaporizes the capture fluid to form a vapor (e.g., liquid to gas phase transformation). For example, the capture fluid may be heated to 100 to 400° C., alternatively to 180 to 250° C.

A jet assembly 111 can be in fluid communication with the reservoir 107 and the jet assembly 111 can comprise nozzles 113 for discharging the vaporized capture fluid into the chamber 101. The vaporized capture fluid flows and rises up though the jet assembly 111 and is emitted out the nozzles 113. The flow of the vaporized capture fluid is illustrated in FIG. 3 using arrows. The vaporized capture fluid condenses and flows back to the reservoir 107. For example, the nozzle 113 can discharge the vaporized capture fluid against a wall of the chamber 101. Walls of the chamber 101 may be cooled with a cooling system 114 such as a water cooled system. Cooled walls of the chamber 101 can cause the vaporized capture fluid to condense. The condensed capture fluid can then flow along and down the walls of the chamber 101 and back to the reservoir 107 under the force of gravity. The capture fluid can be continuously cycled through diffusion pump 120. The flow of the capture fluid causes gas that enters the inlet 103 to diffuse from the inlet 103 to the outlet 105 of the chamber 101. A vacuum source 33 may be in fluid communication with the outlet 105 of the chamber 101 to assist removal of the gas from the outlet 105.

As gas flows through the chamber 101, nanoparticles entrained in the gas (e.g. the silicon nanoparticles of the nanoparticle aerosol) can be absorbed by the capture fluid, which thereby collects the silicon nanoparticles from the gas. For example, a surface of the silicon nanoparticles may be wetted by the vaporized and/or condensed capture fluid. Agitating of cycled capture fluid may further improve absorption rate of the silicon nanoparticles compared to a static fluid. The pressure within the chamber 101 may be less than 1 mTorr.

The capture fluid with the silicon nanoparticles can be removed from the diffusion pump 120. For example, the capture fluid with the silicon nanoparticles may be continuously removed and replaced with capture fluid that substantially does not include silicon nanoparticles.

Advantageously, the diffusion pump 120 can be used not only for collecting silicon nanoparticles but also for evacuating the plasma generating chamber 22 and collection chamber 26. For example, the operating pressure in the plasma generating chamber 22 can be a low pressure, e.g. less than atmospheric pressure, less than 760 Torr, or between 1 and 760 Torr. The collection chamber 26 can, for example, range from 1 to 5 milliTorr or have a pressure of less than 1×10⁻⁵ Torr. Other operating pressures are also contemplated.

The plasma reactor system 50 may also include the vacuum pump or vacuum source 33 in fluid communication with the outlet 105 of the diffusion pump 120. The vacuum source 33 can be selected in order for the diffusion pump 120 to operate properly. In one form of the present embodiment, the vacuum source 33 comprises the vacuum pump (e.g., auxiliary pump). The vacuum source 33 may comprise a mechanical, turbo molecular, or cryogenic pump. However, other vacuum sources may alternatively, or additionally, be utilized.

In some embodiments, the method includes utilizing the plasma reactor system 50 of FIG. 2 for forming a nanoparticle aerosol in the plasma generating chamber 22. The nanoparticle aerosol can comprise the silicon nanoparticles in a gas, and the method further includes introducing the nanoparticle aerosol into the diffusion pump 120 from the plasma generating chamber 22. In such embodiments, the method also may include heating the capture fluid in the reservoir 107 to form a vapor, sending the vapor through the jet assembly 111, emitting the vapor through nozzles 113 and into the chamber 101 of the diffusion pump 120, condensing the vapor to form a condensate, and flowing the condensate back to the reservoir 107. The method can also include capturing and collecting the silicon nanoparticles of the nanoparticle aerosol in the capture fluid condensate in the reservoir 107. The action of capturing the silicon nanoparticles of the nanoparticle aerosol in the capture fluid condensate may be identical to the action of collecting the silicon nanoparticles of the nanoparticle aerosol in the capture fluid. The method can further include removing the gas from the diffusion pump 120 with the vacuum source 33. As compared to the embodiments described with reference to FIG. 1 above, where the silicon nanoparticles are collected directly in capture fluid 27, the plasma reactor system 50 utilizes a vaporized form of the capture fluid that is condensed in the diffusion pump 120 where it is utilized to capture/collected the silicon nanoparticles from the nanoparticle aerosol.

As introduced above, the nanoparticle aerosol formed in the plasma reactor comprises nanoparticles in a gas. With respect to the gas, one of skill in the art will readily appreciate that the gas comprises those gases introduced to the plasma reactor, such various gaseous components of the reactant gas mixture from which the silicon nanoparticles are formed, which are described in detail below.

Independent of the particular low pressure reactor utilized to prepare the nanoparticle aerosol, the silicon nanoparticles are collected, optionally in the capture fluid or diffusion pump fluid, which may also serve as the capture fluid.

If utilized, the capture fluid may comprise any compounds, components, or fluids that may be suitable for capturing the silicon nanoparticles. For example, conventional components utilized in conventional capture fluids may be utilized as the capture fluid. Specific examples of conventional capture fluids include silicone fluids, such as polydimethylsiloxane, phenylmethyl-dimethyl cyclosiloxane, tetramethyltetraphenyltrisiloxane, and/or pentaphenyltrimethyltrisiloxane; hydrocarbons; phenyl ethers; fluorinated polyphenyl ethers; sulfoxides (e.g., anhydrous methyl sulfoxide); hydrocarbon fluids; silicon-containing fluids; fluorocarbon fluids; and ionic liquids. Combinations of different components may be utilized in the capture fluid. The capture fluid may have a dynamic viscosity of 0.001 to 1 Pa·s, 0.005 to 0.5 Pa·s, alternatively 0.01 to 0.2 Pa·s, at 23±3° C. Furthermore, the capture fluid may have a vapor pressure of less than 1×10⁻⁴ Torr. A low viscosity of the capture fluid is necessary to allow the silicon nanoparticles to be injected into or absorbed by the capture fluid without forming a film on the capture fluid's surface. In some embodiments, the capture fluid is at a temperature ranging from −20° C. to 150° C. and a pressure ranging from 1 to 5 milliTorr (0.133 Pa to 0.665 Pa). In some embodiments, the capture fluid has a vapor pressure less than the pressure in the particle collection chamber 26.

It is contemplated that the capture fluid may be used as a material handling and storage medium. In one embodiment, the capture fluid is selected to allow nanoparticles to be absorbed and dispersed into the capture fluid as the silicon nanoparticles are collected, thus forming a dispersion or suspension of nanoparticles in the capture fluid.

The silicon nanoparticles may exhibit a number of unique electronic, magnetic, catalytic, physical, optoelectronic and optical properties due to quantum confinement effects. For example, many semiconductor nanoparticles exhibit photoluminescence effects that are significantly greater than the photoluminescence effects of macroscopic materials of similar composition.

A diameter of the silicon nanoparticles can be calculated from the following equation:

$${D}_{p} = \frac{2.57811}{{( h \cdot c \text{/} λ - {E}_{g} )}^{1 \text{/} 1.39}}$$

As set forth in Proot, et. al. Appl. Phys. Lett., 61, 1948 (1992); Delerue, et. al. Phys. Rev. B., 48, 11024 (1993); and Ledoux, et. al. Phys. Rev. B., 62, 15942 (2000), where h is Plank's constant, c is the speed of light, and E_{g} is the bulk band gap of silicon.

The functionalized nanoparticles and/or the silicon nanoparticles may independently have a largest dimension or average largest dimension less than 50, alternatively less than 20, alternatively less than 10, alternatively less than 5 nm. Optionally the silicon nanoparticles include a largest dimension of greater than 0.1 nm. Furthermore, the largest dimension or average largest dimension of the silicon nanoparticles may be between 1 and 50, alternatively between 2 and 50, alternatively between 2 and 20, alternatively between 2 and 10, alternatively between 2.2 and 4.7 nm. The largest dimension of the silicon nanoparticles can be measured by a variety of methods, such as with a transmission electron microscope (TEM). For example, as understood in the art, particle size distributions are often calculated via TEM image analysis of hundreds of different nanoparticles. In various embodiments, the silicon nanoparticles may comprise quantum dots, typically silicon quantum dots. Quantum dots have excitons confined in all three spatial dimensions and may comprise individual crystals, i.e., each quantum dot is a single crystal.

In various embodiments, the silicon nanoparticles may be photoluminescent when excited by exposure to UV light. Depending on the average diameter of the silicon nanoparticles, the silicon nanoparticles may photoluminescence in any of the wavelengths in the visible spectrum and may visually appear to be red, orange, green, blue, violet, or any other color in the visible spectrum. For example, when the silicon nanoparticles have an average diameter of less than 5 nm, visible photoluminescence may be observed, and when the silicon nanoparticles have an average diameter less than 10 nm near infrared (IR) luminescence may be observed. In one form of the present disclosure, the silicon nanoparticles have a photoluminescent intensity of at least 1×10⁶ at an excitation wavelength of 365 nm. The photoluminescent intensity may be measured with a Fluorolog3 spectrofluorometer (commercially available from Horiba of Edison, N.J.) with a 450 W Xe excitation source, excitation monochromator, sample holder, edge band filter (400 nm), emission monochromator, and a silicon detector photomultiplier tube. To measure photoluminescent intensity, the excitation and emission slit width are set to 2 nm and the integration time is set to 0.1 s. In these or other embodiments, the silicon nanoparticles may have a quantum efficiency of at least 4% at an excitation wavelength of 395 nm as measured on an HR400 spectrophotometer (commercially available from Ocean Optics of Dunedin, Fla.) via a 1000 micron optical fiber coupled to an integrating sphere and the spectrophotometer with an absorption of >10% of the incident photons. Quantum efficiency is calculated by placing a sample into the integrating sphere and exciting the sample via a 395 nm LED driven by an Ocean Optics LED driver. The system was calibrated with a known lamp source to measure absolute irradiance from the integrating sphere. The quantum efficiency is then calculated by the ratio of total photons emitted by the silicon nanoparticles to the total photons absorbed by the silicon nanoparticles. Further, in these or other embodiments, the silicon nanoparticles may have a full width at half maximum emission of from 20 to 250 at an excitation wavelength of 270-500 nm.

Without wishing to be bound to a particular theory, photoluminescence of the silicon nanoparticles is thought to be caused by a quantum confinement effect that occurs when the diameter of the silicon nanoparticles is smaller than the excitation radius, which results in bandgap bending (i.e., increasing of the gap). The bandgap energy of a nanoparticle changes as a function of the diameter of the nanoparticle. Although silicon is an indirect bandgap semiconductor in bulk, silicon nanoparticles with diameters of less than 5 nm emulate a direct bandgap material, which is made possible by interface trapping of excitons.

Furthermore, both the photoluminescent intensity and luminescent quantum efficiency may continue to increase over time, particularly when the silicon nanoparticles are exposed to air to passivate surfaces of the silicon nanoparticles. In another form of the present disclosure, the maximum emission wavelength of the silicon nanoparticles shifts to shorter wavelengths (i.e., a blue-shift of an emission spectrum) over time when passivated (e.g., being exposed to oxygen). The luminescent quantum efficiency of the silicon nanoparticles may be increased by 200% to 2500% upon passivation. However, other increases in the luminescent quantum efficiency are also contemplated. The photoluminescent intensity may increase from 400 to 4500% depending on time extent of passivation and concentration of the silicon nanoparticles in a fluid in which they are suspended. However, other increases in the photoluminescent intensity are also contemplated. The wavelength spectrum for light emitted from the silicon nanoparticles experiences a blue shift with passivation of the silicon nanoparticles. In one form of the present disclosure, a maximum emission wavelength undergoes a blue-shift of 100 nm, corresponding to an approximately 1 nm decrease in nanoparticle size, depending on time duration of passivation. However, other maximum emission wavelength shifts are also contemplated herein. Alternative means of passivation include contacting the silicon nanoparticles with a nitrogen-containing gas such as ammonia to create a surface layer on the silicon nanoparticles where the surface layer comprises nitride.

The following examples, illustrating the compositions and methods of this disclosure, are intended to illustrate and not to limit the disclosure.

### Examples 1 and 2 and Comparative Example 1

A optical emission spectrometer, Ocean Optics PlasCalc-2000-UV/VIS/NIR, was attached to a very high frequency low pressure plasma reactor. This spectrometer a fiber based spectrometer with a spectral range from 200-1100 nm with a 1 nm full width half maximum (FW HM) optical resolution. This spectrometer was placed above the plasma looking down the axis of the discharge tube via a quartz window instead of radial to remove the wall deposition attenuation. The optical emission spectrometer spectrums were analyzed off line with the Ocean Optics SpecLine software to identify the atomic and molecular emission species.

Silicon nanoparticles are produced in the plasma reactor. In Examples 1 and 2, the method of producing the nanoparticles including first introducing a halogen gas (Cl₂) and argon (Ar) and igniting a plasma in the reaction chamber of the plasma reactor prior to introducing a reactant gas mixture to the reaction chamber to produce silicon nanoparticles. In Comparative Example 1, the same process is carried out to produce silicon nanoparticles as in Examples 1 and 2, but there is no first step of introducing a halogen gas into the reaction chamber and igniting a plasma in the reaction chamber prior to producing the silicon nanoparticles. The silicon nanoparticles of Examples 1 and 2 have higher emission intensity (1.5-2.25 times peak intensities) as compared to the silicon nanoparticles of Comparative Example 1 when measured at a right angle on a Horiba FL3 spectrofluorometer.

Tables 1 and 2 below set forth the parameters/conditions associated with Examples 1 and 2 and Comparative Example 1. In Tables 1 and 2, gas precursor values are gas volume percentage, frequency is radio frequency of the plasma, P_{F} is forward power, P_{R} is reflected power, P_{C} is power coupled, and P_{eff} is power efficiency. PDMS indicates polydimethylsiloxane. The PDMS has a viscosity of 10 cSt at 25° C.

TABLE 1

| | | | | | Discharge | |
|---|---|---|---|---|---|---|
| | | | | | Tube | |
| | Time | Ar | SiH₄ | H₂ | Press | Capture |
| Run | (min) | (vol %) | (vol %) | (vol. %) | (Torr) | Fluid |
| Example 1 | 240 | 91.34 | 0.84 | 7.81 | 3.8 | PDMS |
| Example 2 | 80 | 95.16 | 1.09 | 3.75 | 3.8 | PDMS |
| Comparative | 70 | 95.16 | 1.09 | 3.75 | 3.7 | PDMS |
| Example 1 | | | | | | |

TABLE 2

| | Freq. | P_{F} | P_{R} | P_{C} | P_{eff} |
|---|---|---|---|---|---|
| Example | (MHz) | (W) | (W) | (W) | (%) |
| Example 1 | 135 | 193 | 3 | 190 | 98.45 |
| Example 2 | 135 | 192 | 2 | 190 | 98.96 |
| Comparative | 135 | 192 | 2 | 190 | 98.96 |
| Example 1 | | | | | |

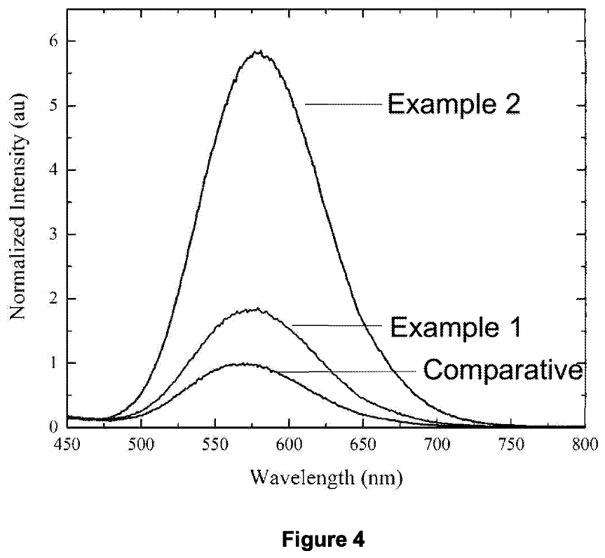

As shown in FIG. 4, the nanoparticles formed in Examples 1 and 2 have higher emission intensity (1.5-2.25 times peak intensities) than those formed in Comparative Example 1 when measured with a Horiba FL3 spectrofluorometer.

### Examples 3-5

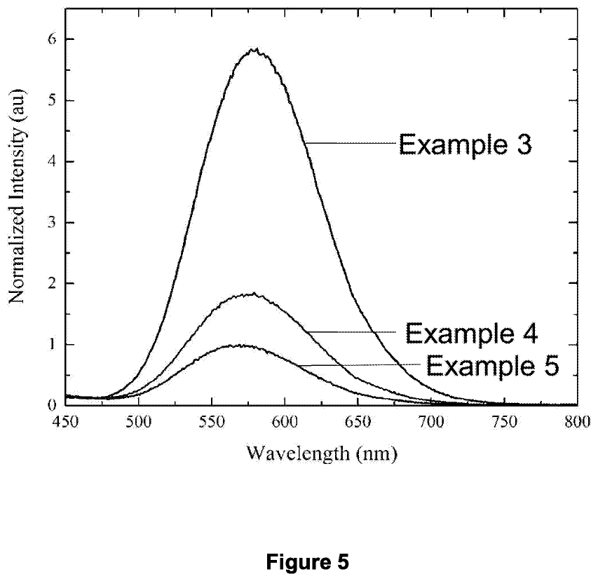

Examples 3-5 are identical to one another, with one caveat. Example 3 utilizes the inventive method and follows Examples 1 and 2 (with the exception of certain parameters, including time). Each of Examples 3-5 utilizes a short deposition time (20 minutes). Examples 4 and 5 were carried out after Example 3, but without additional steps of introducing a halogen gas into the reaction chamber prior to producing nanoparticles. Thus, Examples 4 and 5 only utilize the step of introducing the halogen gas and igniting a plasma from Example 3. The peak emission intensity of the silicon nanoparticles of Example 3 is almost 6 times greater than peak emission intensity of the silicon nanoparticles of Examples 4 and 5 when measured with a Horiba FL3 spectrofluorometer, as shown in FIG. 5.

Tables 3 and 4 below set forth the parameters/conditions associated with Examples 3-5. In Tables 3 and 4, gas precursor values are gas volume percentage, frequency is radio frequency of the plasma, P_{F} is forward power, P_{R} is reflected power, P_{C} is power coupled, and P_{eff} is power efficiency. PDMS indicates polydimethylsiloxane. The PDMS has a viscosity of 10 cSt at 25° C.

TABLE 3

| | | | | | Discharge | |
|---|---|---|---|---|---|---|
| | | | | | Tube | |
| | Time | Ar | SiH₄ | H₂ | Press | Capture |
| Run | (min) | (vol %) | (vol %) | (vol. %) | (Torr) | Fluid |
| Example 3 | 20 | 94.23 | 0.36 | 5.41 | 2.48 | PDMS |
| Example 4 | 20 | 94.23 | 0.36 | 5.41 | 2.5 | PDMS |
| Example 5 | 20 | 94.23 | 0.36 | 5.41 | 2.52 | PDMS |

TABLE 4

| | Freq. | P_{F} | P_{R} | P_{C} | P_{eff} |
|---|---|---|---|---|---|
| Run | (MHz) | (W) | (W) | (W) | (%) |
| Example 3 | 129 | 190 | 70 | 120 | 63.16 |
| Example 4 | 129 | 190 | 70 | 120 | 63.16 |
| Example 5 | 129 | 190 | 70 | 119 | 62.96 |

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A method for producing silicon nanoparticles in a plasma reactor including a reaction chamber presenting an inner surface, the method comprising:
i) introducing a halogen gas into the reaction chamber of the plasma reactor;
ii) igniting a plasma within the reaction chamber while the halogen gas is present within the reaction chamber, wherein atoms of the halogen gas at least partially form a coating on the inner surface of the reaction chamber, the coating comprising halogen atoms, wherein step ii) is carried out prior to step iii), and/or wherein step ii) is carried out in the absence of any silicon precursor gas;
iii) introducing a reactant gas mixture comprising a silicon precursor gas and a first inert gas into the reaction chamber of the plasma reactor; and
iv) forming the silicon nanoparticles in the plasma reactor.

2. The method of claim 1, wherein the inner surface has a first coating comprising silicon atoms, and wherein the coating formed with the halogen gas comprises silicon atoms and halogen atoms.

3. The method of claim 1, wherein the introduction of the halogen gas to the reaction chamber is prior to the introduction of the reactant gas mixture, and wherein an initial inert gas is introduced into the reaction chamber with the halogen gas.

4. The method of claim 1, wherein after the reactant gas mixture is first introduced into the reaction chamber, halogen gas is introduced to the reaction chamber with the reactant gas mixture.

5. The method of claim 2, wherein igniting a plasma within the reaction chamber while the halogen gas is present within the reaction chamber forms a halosilane in the reaction chamber from the first coating comprising silicon atoms and the halogen gas.

6. The method of claim 1, wherein halogen gas is present in the reaction chamber with the reactant gas mixture during the production of the silicon nanoparticles.

7. The method of claim 1, wherein the halogen gas is chlorine gas and the halogen atoms are chlorine atoms.

8. The method of claim 1, wherein the reactant gas mixture further comprises a second precursor gas comprising an element selected from the group consisting of carbon, germanium, boron, phosphorous, and nitrogen.

9. The method of claim 1, further comprising collecting the silicon nanoparticles in a capture fluid in a vacuum particle collection chamber, wherein a pressure of the vacuum particle collection chamber is less than a pressure of the reaction chamber.

10. The method of claim 9, wherein the capture fluid comprises a hydrocarbon fluid, a silicon-containing fluid, or a fluorocarbon fluid.

11. The method of claim 10, wherein the capture fluid further comprises a doping compound.

12. The method of claim 1, wherein igniting a plasma comprises applying a preselected radio frequency having a continuous frequency of from 10 to 500 MHz and a coupled power of from 5 to 1000 W to the reaction chamber.

13. The method of claim 1, further comprising:
introducing the silicon nanoparticles into a diffusion pump from the plasma reactor;
heating the capture fluid in a reservoir to form a vapor and sending the vapor through a jet assembly;
emitting the vapor through a nozzle into a chamber of the diffusion pump and condensing the vapor to form a condensate comprising the capture fluid;
flowing the condensate back to the reservoir; and
capturing the silicon nanoparticles in the condensate comprising the capture fluid.

14. The method of claim 2, further comprising forming the first coating on the inner surface of the reaction chamber.

15. Silicon nanoparticles produced by the method of claim 1.

16. The method of claim 9, wherein the capture fluid comprises a doping compound.
